(19) United States
(12) Patent Application Publication
(10) Pub. No.: US 2011/0313086 A1
(43) Pub. Date: Dec. 22, 2011

(54) POLYOXYMETHYLENES FOR DIESEL APPLICATIONS

(75) Inventors: Karthikeyan Sharavanan, Mannheim (DE); Jürgen Demeter, Ludwigshafen (DE)

(73) Assignee: BASF SE, Ludwigshafen (DE)

(21) Appl. No.: 13/148,727

(22) PCT Filed: Feb. 8, 2010
(86) PCT No.: PCT/EP10/51456

§ 371 Date: Aug. 10, 2011

(30) Foreign Application Priority Data
Feb. 11, 2009 (EP) 09152559.2

(51) Int. Cl. C08L 71/02; C08K 13/02

(52) U.S. Cl. 524/106

(57) ABSTRACT

Thermoplastic molding materials comprising
A) 10 to 99.99% by weight of a polyoxymethylene homo- or copolymer,
B) 0.01 to 5% by weight of an imidazole of the general formula

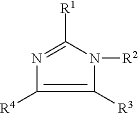

where the R¹ to R⁴ radicals are each independently defined as follows:
R¹ is an alkyl radical having 1 to 5 carbon atoms,
R² to R⁴ are each hydrogen, an alkyl radical having 1 to 5 carbon atoms,
C) 0 to 5% by weight of an alkaline earth metal oxide,
D) 0 to 80% by weight of further additives,
   where the sum of the percentages by weight of components A) to D) adds up to 100%.

The invention relates to thermoplastic molding materials comprising

A) 10 to 99.99% by weight of a polyoxymethylene homo- or copolymer,
B) 0.01 to 5% by weight of an imidazole of the general formula

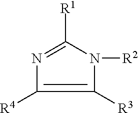

where the R¹ to R⁴ radicals are each independently defined as follows:

R¹ is an alkyl radical having 1 to 5 carbon atoms,

R² to R⁴ are each hydrogen, an alkyl radical having 1 to 5 carbon atoms,

C) 0 to 5% by weight of an alkaline earth metal oxide,
D) 0 to 80% by weight of further additives,
where the sum of the percentages by weight of components A) to D) adds up to 100%.

The invention further relates to the use of the inventive molding materials for producing fibers, films and moldings of any kind, and to the moldings obtainable in this way.

Polyoxymethylenes are often used in the engine area, where they come into contact with diesel fuel, which is at 90° C. and hotter in this area. At these temperatures, molecular weight degradation is a great problem. Furthermore, there are new challenges for these thermoplastics, since biodiesel or diesel fuels with a low sulfur content are being used in the new generation engines.

EP-A 855 424 discloses sterically hindered amines, benzotriazoles, benzoates and benzophenones as stabilizers for POMs.

A combination of polyalkylene glycols and ZnO is known, for example, from U.S. Pat. No. 6,489,388, and WO 2003/027177 discloses a combination of metal hydroxide, metal oxide and antioxidants.

The prior art molding materials are in need of improvement with regard to diesel fuel stability, especially at elevated temperatures and over prolonged periods. Moreover, these POM materials are only of inadequate suitability for the new “diesels”.

It was therefore an object of the present invention to provide POM molding materials which have good diesel fuel stability (especially at elevated temperatures and over prolonged periods), which should also include new diesel fuels and diesel mixtures.

Furthermore, the acid stability, chlorine stability (bleaching) and oxidation stability should be improved.

Accordingly, the molding materials defined at the outset have been found. Preferred embodiments can be inferred from the subclaims.

As component A), the inventive molding materials comprise 10 to 99.99% by weight, particularly 10 to 99.98% by weight, preferably 20 to 99.48% by weight and especially 25 to 98.95% by weight of a polyoxymethylene homo- or copolymer.

Such polymers are known per se to those skilled in the art and are described in the literature.

Quite generally, these polymers have at least 50 mol % of repeat —CH₂O— units in the polymer backbone.

The homopolymers are generally prepared by polymerizing formaldehyde or trioxane, preferably in the presence of suitable catalysts.

In the context of the invention, preference is given to polyoxymethylene copolymers as component A, especially those which, as well as the —CH₂O— repeat units, also have up to 50, preferably 0.1 to 20, especially 0.3 to 10 mol % and most preferably 0.2 to 2.5 mol % of repeat units

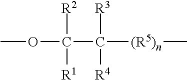

where R¹ to R⁴ are each independently a hydrogen atom, a C₁- to C₄-alkyl group or a halogen-substituted alkyl group having 1 to 4 carbon atoms and R⁵ is a —CH₂—, CH₂O—, a C₁- to C₄-alkyl- or C₁- to Cₐ-haloalkyl-substituted methylene group or a corresponding oxymethylene group, and n is in the range from 0 to 3. Advantageously, these groups can be introduced into the copolymers by ring opening of cyclic ethers. Preferred cyclic ethers are those of the formula

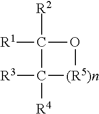

where R¹ to R⁵ and n are each as defined above. The comonomers include, merely by way of example, ethylene oxide, 1,2-propylene oxide, 1,2-butylene oxide, 1,3-butylene oxide, 1,3-dioxane, 1,3-dioxolane and 1,3-dioxepane as cyclic ethers, and also linear oligo- or polyformals such as polydioxolane or polydioxepane.

Likewise suitable as component A) are oxymethylene terpolymers, which are prepared, for example, by reaction of trioxane, one of the above-described cyclic ethers, with a third monomer, preferably bifunctional compounds of the formula

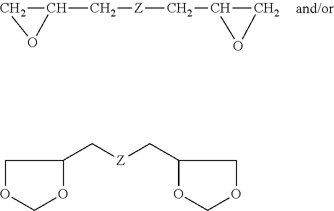

where Z is a chemical bond, —O—, —ORO— (R=C₁- to C₈-alkylene or C₃- to C₈-cycloalkylene).

Preferred monomers of this kind are ethylene diglycide, diglycidyl ether and diethers formed from glycidyls and formaldehyde, dioxane or trioxane in a molar ratio of 2:1, and diethers formed from 2 mol of glycidyl compound and 1 mol of an aliphatic diol having 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol, to mention just a few examples.

Processes for preparing the above-described homo- and copolymers are known to those skilled in the art and are described in the literature, and so no further information is needed here.

The preferred polyoxymethylene copolymers have melting points of at least 160 to 170° C. (DSC, ISO 3146) and molecular weights (weight average) Mw in the range from 5000 to 300 000, preferably from 7000 to 250 000 (GPC, PMMA standard).

End group stabilized polyoxymethylene polymers which have C—C bonds at the chain ends are particularly preferred.

As component B), the inventive molding materials comprise at least one imidazole of the general formula

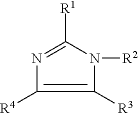

where the R¹ to R⁴ radicals are each independently defined as follows:
R¹ is an alkyl radical having 1 to 5, preferably 1 to 4, carbon atoms, especially a methyl radical or ethyl radical,
R² to R⁴ are each hydrogen or an alkyl radical having 1 to 5, preferably 1 to 4, carbon atoms, especially hydrogen or a methyl radical or an ethyl radical.

Preferred imidazoles are:

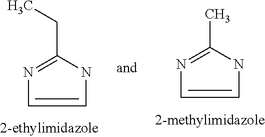

Imidazole can be synthesized from glyoxal, ammonia and formaldehyde, hence the obsolete name glyoxaline; it is also obtainable from bromoacetaldehyde ethylene acetal by heating with formamide to 180° C. while introducing ammonia.

Imidazole derivatives are obtained by the action of formamide and formaldehyde on benzil and other substituted 1,2-diketones at 180-200° C. Imidazole derivatives are likewise obtainable by condensation of α-haloketones with amidines.

As component C), the inventive molding materials comprise 0 to 5, particularly 0.01 to 5, preferably 0.5 to 4 and especially 1 to 3% by weight of an alkaline earth metal oxide. Preference is given to calcium, barium or strontium oxides, particular preference being given to MgO.

MgO, Mᵣ 40.30. Loose white powder or octahedral or cubic crystals with a density of 3.58, m.p. 2827+/−30° C., b.p. approx. 3600° C., insoluble in water, but is converted slowly by it to sparingly soluble magnesium hydroxide. Crystalline MgO forms, for example, in the course of calcination of Mg, and also in the course of calcination of magnesium hydroxide, magnesium carbonate, magnesium nitrate, magnesite, by decomposition of magnesium chloride with superheated steam, thermally from epsomite or kieserite. Obtaining it from seawater involves precipitating Mg(OH)₂ with the aid of quicklime and slaked lime or dolomite, and removing and calcining.

Preferred MgO in accordance with the invention is MgO which comprises only very small proportions of metal impurities (apart from alkali metals), preferably below 10 000 ppm, especially below 7000 ppm.

The preferred mean particle size is from 10 to 200 μm, preferably 20 to 100 μm and especially 50 to 80 μm (determined by sieve analysis).

Suitable MgO is commercially available from Acros Organics and generally has less than 10 000 ppm of secondary constituents of other oxides such as CaO, SiO₂, Al₂O₃, Fe₂O₃, and SO₄-containing salts.

As component D), the inventive molding materials may comprise 0 to 80% by weight, preferably 0 to 50% by weight and especially 0 to 40% by weight of further additives.

As component D), the inventive molding materials may comprise 0.01 to 2% by weight, preferably 0.02 to 0.8% by weight and especially 0.03 to 0.4% by weight of talc, which is a hydrated magnesium silicate of composition Mg₃[(OH)₂/Si₄O₁₀] or 3 MgO.4 SiO₂.H₂O. These so-called three-layer phyllosilicates have a triclinic, monoclinic or rhombic crystal structure with a platelet-shaped appearance. Further trace elements which may be present are Mn, Ti, Cr, Ni, Na and K, in which case the OH group may be partly replaced by fluoride.

Particular preference is given to using talc whose particle sizes are 100%<20 μm. The particle size distribution is typically determined by DIN 6616-1 sedimentation analysis and is preferably:

<20 μm 100% by weight
<10 μm 99% by weight
<5 μm 85% by weight
<3 μm 60% by weight
<2 μm 43% by weight

Such products are commercially available as Micro-Talc I.T. extra (from Norwegian Talc Minerals).

Suitable sterically hindered phenols D) are in principle all compounds with phenolic structure which have at least one sterically demanding group on the phenolic ring.

Preferred examples of compounds of the formula

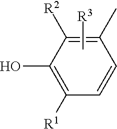

are those in which:

R¹ and R² are each an alkyl group, a substituted alkyl group or a substituted triazole group, where the R1 and R2 radicals may be the same or different and R3 is an alkyl group, a substituted alkyl group, an alkoxy group or a substituted amino group.

Antioxidants of the type mentioned are described, for example, in DE-A 27 02 661 (U.S. Pat. No. 4,360,617).

A further group of preferred sterically hindered phenols derives from substituted benzenecarboxylic acids, especially from substituted benzenepropionic acids.

Particularly preferred compounds from this class are compounds of the formula

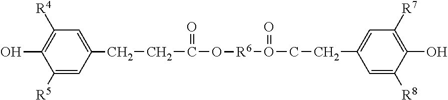

where R4, R5, R7 and R8 are each independently C₁-C₈-alkyl groups which may themselves be substituted (at least one of them is a sterically demanding group) and R6 is a divalent aliphatic radical which has 1 to 10 carbon atoms and may also have C—O bonds in the backbone.

Preferred compounds which correspond to these forms are

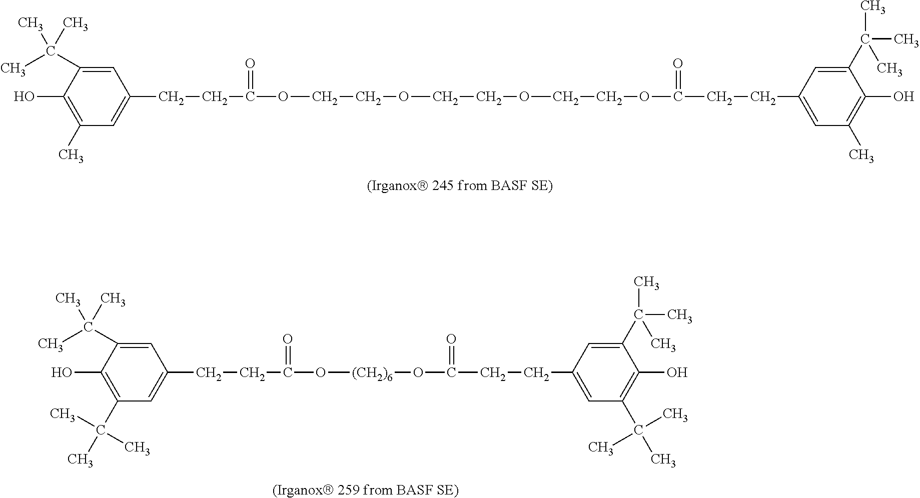

Examples of sterically hindered phenols include:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris-(3,5-di-tert-butyl-4-hydroxybenzyl)benzene, 4,4′-methylenebis(2,6-di-tert-butylphenol), 3,5-di-tert-butyl-4-hydroxybenzyldimethylamine and N,N′-hexamethylenebis-3,5-di-tert-butyl-4-hydroxyhydrocinnamide.

Particularly effective examples, which are therefore used with preference, have been found to be 2,Z-methylenebis(4-methyl-6-tert-butylphenol), 1,6-hexanediol bis(3,5-di-tert-butyl-4-hydroxyphenyl]propionate (Irganox® 259), pentaerythrityl tetrakis[3-(3,5-di-tert-butyl-4-hydroxyphenyl)propionate] and the above-described Irganox® 245 from Ciba Geigy, which is particularly suitable.

The antioxidants (D), which can be used individually or as mixtures, can be used in an amount of 0.005 up to 2% by weight, preferably of 0.1 to 1.0% by weight, based on the total weight of the molding materials A) to D).

In some cases, sterically hindered phenols having not more than one sterically hindered group in the ortho position to the phenolic hydroxyl group have been found to be particularly advantageous, especially in the assessment of color stability in the course of storage in diffuse light over prolonged periods.

The polyamides usable as components D) are known per se. Semicrystalline or amorphous resins, as described, for example, in Encyclopedia of Polymer Science and Engineering, vol. 11, p. 315 to 489, John Wiley & Sons, Inc., 1988, can be used, the melting point of the polyamide preferably being less than 225° C., preferably less than 215° C.

Examples thereof are polyhexamethyleneazelamide, polyhexamethylenesebacamide, polyhexamethylenedodecanediamide, poly-11-aminoundecanamide and bis(p-aminocyclohexyl)methanedodecanediamide, or the products obtained by ring opening of lactams, for example polycaprolactam or polylaurolactam. Also suitable are polyamides based on terephthalic or isophthalic acid as the acid component and/or trimethylhexamethylenediamine or bis(p-aminocyclohexyl)propane as the diamine component, and also polyamide base resins which have been prepared by copolymerization of two or more of the aforementioned polymers or components thereof.

Particularly suitable polyamides include copolyamides based on caprolactam, hexamethylenediamine, p,p′-diaminodicyclohexylmethane and adipic acid. One example thereof is the product sold under the Ultramid® 1 C designation by BASF SE.

Further suitable polyamides are sold by Du Pont under the Elvamide® designation.

The preparation of these polyamides is likewise described in the aforementioned document. The ratio of terminal amino groups to terminal acid groups can be controlled by varying the molar ratio of the starting compounds.

The proportion of the polyamide in the inventive molding material is from 0.001 up to 2% by weight, preferably 0.005 to 1.99% by weight, preferentially 0.01 to 0.08% by weight.

The additional use of a polycondensation product formed from 2,2-di(4-hydroxyphenyl)-propane (bisphenol A) and epichlorohydrin can in some cases improve the dispersibility of the polyamides used.

Such condensation products formed from epichlorohydrin and bisphenol A are commercially available. Processes for preparation thereof are likewise known to those skilled in the art. Commercial designations of the polycondensates are Phenoxy® (from Union Carbide Corporation) and Epikote® (from Shell). The molecular weight of the polycondensates can vary within wide limits; in principle, all of the commercially available types are suitable.

As component D), the inventive polyoxymethylene molding materials may comprise 0.002 to 2.0% by weight, preferably 0.005 to 0.5% by weight and especially 0.01 to 0.3% by weight, based on the total weight of the molding materials, of one or more of the alkaline earth metal silicates and/or alkaline earth metal glycerophosphates. Advantageous alkaline earth metals for forming the silicates and glycerophosphates have been found to be preferably calcium and especially magnesium. It is appropriate to use calcium glycerophosphate and preferably magnesium glycerophosphate and/or calcium silicate and preferably magnesium silicate, the preferred alkaline earth metal silicates especially being those described by the formula

Me.xSiO₂nH₂O

in which
Me is an alkaline earth metal, preferably calcium or especially magnesium,
x is from 1.4 to 10, preferably 1.4 to 6, and
n is greater than or equal to 0, preferably 0 to 8.

The compounds D) are advantageously used in finely ground form. Products with an average particle size of less than 100 μm, preferably of less than 50 μm, are particularly suitable.

Preference is given to using calcium and magnesium silicates and/or calcium and magnesium glycerophosphates. These can be specified in detail, for example, by the following characteristics:

calcium or magnesium silicate:
CaO or MgO content: 4 to 32% by weight, preferably 8 to 30% by weight and especially 12 to 25% by weight,
SiO₂:CaO or SiO₂:MgO ratio (mol/mol): 1.4 to 10, preferably 1.4 to 6 and especially 1.5 to 4,
bulk density: 10 to 80 g/100 ml, preferably 10 to 40 g/100 ml, and average particle size: less than 100 μm,
preferably less than 50 μm, and
calcium or magnesium glycerophosphate:
CaO or MgO content: greater than 70% by weight, preferably greater than 80% by weight
ignition residue: 45 to 65% by weight
melting point: greater than 300° C. and
average particle size: less than 100 μm, preferably less than 50 μm.

As component D), the inventive molding materials may comprise from 0.01 to 5, preferably from 0.09 to 2 and especially from 0.1 to 0.7% by weight of at least one ester or amide of saturated or unsaturated aliphatic carboxylic acids having 10 to 40 carbon atoms, preferably 16 to 22 carbon atoms, with polyols or aliphatic saturated alcohols or amines having 2 to 40 carbon atoms, preferably 2 to 6 carbon atoms, or an ether derived from alcohols and ethylene oxide.

The carboxylic acids may be mono- or dibasic. Examples include pelargonic acid, palmitic acid, lauric acid, margaric acid, dodecanedioic acid, behenic acid and more preferably stearic acid, capric acid and montanic acid (mixture of fatty acids having 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono- to trifunctional. Examples thereof are stearylamine, ethylenediamine, propylenediamine, hexamethylenediamine, di(6-aminohexyl)amine, particular preference being given to ethylenediamine and hexamethylenediamine. Preferred esters or amides are accordingly glyceryl distearate, glyceryl tristearate, ethylenediamine distearate, glyceryl monopalmitate, glyceryl trilaurate, glyceryl monobehenate and pentaerythrityl tetrastearate.

It is also possible to use mixtures of different esters or amides or esters with amides in combination, the mixing ratio being as desired.

Additionally suitable are polyetherpolyols or polyesterpolyols which have been esterified or etherified with mono- or polybasic carboxylic acids, preferably fatty acids. Suitable products are commercially available, for example, as Loxiol® EP 728 from Henkel KGaA.

Preferred ethers which derive from alcohols and ethylene oxide have the general formula

RO(CH₂CH₂O)ₙH

in which R is an alkyl group having 6 to 40 carbon atoms and n is an integer greater than/equal to 1.

Especially preferred for R is a saturated C16 to C18 fatty alcohol where n is 50, which is commercially available as Lutensol® AT 50 from BASF SE.

As further components D), the inventive molding materials may comprise 0.0001 to 1% by weight, preferably 0.001 to 0.8% by weight and especially 0.01 to 0.3% by weight of further nucleating agents.

Useful nucleating agents include all known compounds, for example melamine cyanurate, boron compounds such as boron nitride, silica, pigments, for example Heliogen Blue® (copper phthalocyanine pigment; registered trademark of BASF SE).

Fillers in amounts up to 50% by weight, preferably 5 to 40% by weight, include, for example potassium titanate whiskers, carbon fibers and preferably glass fibers, the glass fibers being usable, for example, in the form of glass wovens, mats or webs and/or glass filament rovings or chopped glass filaments made from low-alkali E glass with a diameter of 5 to 200 μm, preferably 8 to 50 μm, the fibrous fillers after incorporation preferably having a mean length of 0.05 to 1 mm, especially 0.1 to 0.5 mm.

Other suitable fillers are, for example, calcium carbonate or glass beads, preferably in ground form, or mixtures of these fillers.

Further additives include, in amounts up to 50% by weight, preferably 0 to 40% by weight, impact modifying polymers (also referred to hereinafter as rubber-elastic polymers or elastomers).

Preferred kinds of such elastomers are the so-called ethylene-propylene (EPM) and ethylene-propylene-diene (EPDM) rubbers.

EPM rubbers generally have virtually no double bonds any longer, whereas EPDM rubbers may have 1 to 20 double bonds/100 carbon atoms.

Examples of diene monomers for EPDM rubbers include, for example, conjugated dienes such as isoprene and butadiene, nonconjugated dienes having 5 to 25 carbon atoms such as penta-1,4-diene, hexa-1,4-diene, hexa-1,5-diene, 2,5-dimethylhexa-1,5-diene and octa-1,4-diene, cyclic dienes such as cyclopentadiene, cyclohexadienes, cyclooctadienes and dicyclopentadiene, and also alkenylnorbornenes such as 5-ethylidene-2-norbornene, 5-butylidene-2-norbornene, 2-methallyl-5-norbornene, 2-isopropenyl-5-norbornene, and tricyclodienes such as 3-methyltricyclo-[5.2.1.0^{2,6}]-3,8-decadiene or mixtures thereof. Preference is given to hexa-1,5-diene, 5-ethylidenenorbornene and dicyclopentadiene. The diene content of the EPDM rubbers is preferably 0.5 to 50 and especially 1 to 8% by weight, based on the total weight of the rubber.

The EPDM rubbers can also be grafted with further monomers, for example with glycidyl(meth)acrylates, (meth)acrylic esters and (meth)acrylamides.

A further group of preferred rubbers is that of copolymers of ethylene with esters of (meth)acrylic acid. In addition, the rubbers may also comprise monomers comprising epoxy groups. These monomers comprising epoxy groups are preferably incorporated into the rubber by adding monomers which comprise epoxy groups and are of the general formula I or II to the monomer mixture

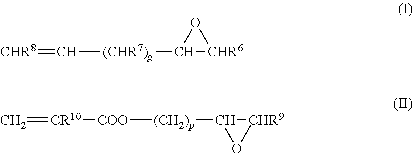

where R⁶-R¹⁰ are each hydrogen or alkyl groups having 1 to 6 carbon atoms and m is an integer from 0 to 20, g an integer from 0 to 10 and p an integer from 0 to 5.

The R⁶ to R⁸ radicals are preferably each hydrogen, where m is 0 or 1 and g is 1. The corresponding compounds are allyl glycidyl ether and vinyl glycidyl ether.

Preferred compounds of the formula H are esters of acrylic acid and/or methacrylic acid which comprise epoxy groups, such as glycidyl acrylate and glycidyl methacrylate.

Advantageously, the copolymers consist of 50 to 98% by weight of ethylene, 0 to 20% by weight of monomers comprising epoxy groups, and the remaining amount of (meth)acrylic esters.

Particular preference is given to copolymers formed from

50 to 98, especially 55 to 95% by weight and of ethylene,
0.1 to 40, especially 0.3 to 20% by weight and of glycidyl acrylate and/or glycidyl methacrylate, (meth)acrylic acid and/or maleic anhydride, and
1 to 50, especially 10 to 40% by weight and of n-butyl acrylate and/or 2-ethylhexyl acrylate.

Further preferred esters of acrylic acid and/or methacrylic acid are the methyl, ethyl, propyl and i- or t-butyl esters.

In addition, it is also possible to use vinyl esters and vinyl ethers as comonomers.

The above-described ethylene copolymers can be prepared by processes known per se, preferably by random copolymerization under high pressure and elevated temperature. Corresponding processes are common knowledge.

Preferred elastomers are also emulsion polymers, the preparation of which is described, for example, by Blackley in the monograph “Emulsion Polymerization”. The emulsifiers and catalysts usable are known per se.

In principle, it is possible to use elastomers of homogeneous structure or else those with a shell structure. The shell-type structure is influenced by factors including the sequence of addition of the individual monomers; the morphology of the polymers is also influenced by this sequence of addition.

Merely for illustrative purposes, monomers for the preparation of the rubber part of the elastomers include acrylates, for example n-butyl acrylate and 2-ethylhexyl acrylate, corresponding methacrylates, butadiene and isoprene, and mixtures thereof. These monomers can be copolymerized with further monomers, for example styrene, acrylonitrile, vinyl ethers and further acrylates or methacrylates such as methyl methacrylate, methyl acrylate, ethyl acrylate and propyl acrylate.

The soft or rubber phase (with a glass transition temperature of less than 0° C.) of the elastomers may be the core, the outer shell or a middle shell (in the case of elastomers with a more than two-shell structure); in the case of multishell elastomers, it is also possible for more than one shell to consist of one rubber phase.

When, as well as the rubber phase, one or more hard components (with glass transition temperatures of more than 20° C.) are involved in the structure of the elastomer, they are generally prepared by polymerizing styrene, acrylonitrile, methacrylonitrile, α-methylstyrene, p-methylstyrene, acrylic esters and methacrylic esters such as methyl acrylate, ethyl acrylate and methyl methacrylate as main monomers. In addition, it is also possible here to use smaller proportions of further comonomers.

In some cases, it has been found to be advantageous to use emulsion polymers which have reactive groups on the surface. Such groups are, for example, epoxy, amino or amide groups, and also functional groups which can be introduced through additional use of monomers of the general formula

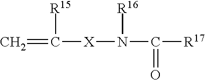

where the substituents may each be defined as follows:
R¹⁵ is hydrogen or a C₁- to C₄-alkyl group,
R¹⁶ is hydrogen, a C₁- to C₈-alkyl group or an aryl group, especially phenyl,
R¹⁷ is hydrogen, a C₁- to C₁₀-alkyl group, a C₆- to C₁₂-aryl group or —OR¹⁵
R¹⁸ is a C₁- to C₈-alkyl or C₆- to C₁₂-aryl group which may optionally be substituted by O- or N-containing groups,

X is a chemical bond, a C₁- to C₁₀-alkylene or C₆-C₁₂-arylene group or

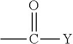

Y is OZ or NH—Z and

Z is a C₁ to C₁₀-alkylene or C₆ to C₁₂-arylene group

The graft monomers described in EP-A 208 187 are also suitable for introducing reactive groups at the surface.

Further examples include acrylamide, methacrylamide and substituted esters of acrylic acid or methacrylic acid, such as (N-t-butylamino)ethyl methacrylate, (N,N-dimethylamino)ethyl acrylate, (N,N-dimethylamino)methyl acrylate and (N,N-diethylamino)ethyl acrylate.

In addition, the particles of the rubber phase may also be crosslinked. Monomers acting as crosslinkers are, for example, buta-1,3-diene, divinylbenzene, diallyl phthalate, butanediol diacrylate and dihydrodicyclopentadienyl acrylate, and the compounds described in EP-A 50 265.

Moreover, it is also possible to use so-called graftlinking monomers, i.e. monomers with two or more polymerizable double bonds which react at different rates in the polymerization. Preference is given to using those compounds in which at least one reactive group polymerizes at about the same rate as the other monomers, while the other reactive group (or reactive groups) polymerizes (polymerize), for example, significantly more slowly. The different polymerization rates cause a particular proportion of unsaturated double bonds in the rubber. When a further phase is then grafted onto such a rubber, the double bonds present in the rubber react at least partly with the graft monomers to form chemical bonds, i.e. the phase grafted on is joined to the graft base at least partly via chemical bonds.

Examples of such graftlinking monomers are monomers comprising allyl groups, especially allyl esters of ethylenically unsaturated carboxylic acids such as allyl acrylate, allyl methacrylate, diallyl maleate, diallyl fumarate, diallyl itaconate or the corresponding monoallyl compounds of these dicarboxylic acids. In addition, there is a multitude of further suitable graftlinking monomers; for further details, reference is made here, for example, to U.S. Pat. No. 4,148,846.

In general, the proportion of these crosslinking monomers in the component C) is up to 5% by weight, preferably not more than 3% by weight, based on C).

Some preferred emulsion polymers are listed below. These firstly include graft polymers with a core and at least one outer shell, which have the following structure:

| Monomers for the core | Monomers for the shell |
|---|---|
| buta-1,3-diene, isoprene, n- | styrene, acrylonitrile, (meth)acrylates, |
| butyl acrylate, ethylhexyl acrylate | optionally with reactive groups as |
| or mixtures thereof, optionally to- | described herein |
| gether with crosslinking monomers | |

Instead of graft polymers with a multishell structure, it is also possible to use homogeneous, i.e. single-shell, elastomers formed from buta-1,3-diene, isoprene and n-butyl acrylate or copolymers thereof. These products too can be prepared by additional use of crosslinking monomers or monomers with reactive groups.

The elastomers C) described can also be prepared by other customary processes, for example by suspension polymerization.

Further suitable elastomers include thermoplastic polyurethanes, which are described, for example, in EP-A 115 846, EP-A 115 847 and EP-A 117 664.

It will be appreciated that it is also possible to use mixtures of the rubber types listed above.

The inventive molding materials may also comprise further customary additives and processing assistants. Merely by way of examples, these include additives for scavenging formaldehyde (formaldehyde scavengers), plasticizers, adhesion promoters and pigments. The proportion of such additives is generally in the range from 0.001 to 5% by weight.

The inventive thermoplastic molding materials are prepared by mixing the components in a manner known per se, and there is therefore no need for any details here. The components are advantageously mixed in an extruder.

Components B) and C) and optionally component(s) D) may, in a preferred mode of preparation, preferably be applied at room temperature to the granule from A) and then extruded.

The molding materials can be used to produce moldings (including semifinished products, foils, films and foams) of all kinds. The molding materials are notable for very good diesel stability, chlorine stability and solvent stability with simultaneously good mechanical properties and thermal stability.

More particularly, the processing of the individual components (without lump formation or caking) is possible without any problem and within short cycle times, and so thin-wall components in particular are possible as an application.

These components are suitable for producing fibers and monofils, foils and moldings of any kind, especially for applications of the following type:

brush attachments for electric toothbrushes
valve bodies and valve housings for WC flush systems
faucets and functional parts of faucets, e.g. single-lever mixers
shower heads and media-conveying internal components
nozzles, bearings, and control elements for irrigation and sprinkler systems and
headlamp wash systems
housings for water filters
brew units for coffee machines
aerosol metering valves and functional parts for sprays
rollers and functional parts for drawer rails
containers, closure caps, and displacers for deodorant sticks, lipsticks, cosmetics products
bearing elements, guide bushes, and slide bushes for mechanical engineering and for motor vehicle construction
gearwheels, spindles, worms, and other components for transmission gearboxes,
variable speed gearboxes, and shift transmission systems
conveyor belts
liquids containers, lids and closures for liquids, inter alia in motor vehicle construction
tank lids, tank flanges, filters, housings for filters, pipes, reservoir casings, roll-over valves of fuel systems in motor vehicle construction
intake manifolds
gas meters.

In the kitchen and household sector, the improved-flow POM can be used to produce components for kitchen appliances, for example fryers, irons, buttons, and also garden and leisure applications, for example components for irrigation systems or garden machinery.

### EXAMPLES

The following components were used:

### Component A)

Polyoxymethylene copolymer formed from 98.8% by weight of trioxane and 1.2% by weight of butanediol formal. The product also comprised approx. 6 to 8% by weight of unconverted trioxane and 5% by weight of thermally unstable components. After degradation of the thermally unstable components, the copolymer had a melt volume flow rate MVR of 9.5 cm³/10 min (melting temperature 190° C., nominal load 2.16 kg, to ISO 1133).

### Component B/1:

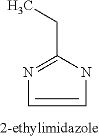

### Component B/2:

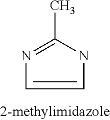

### Comparative Components B/1V

Tinuvin® 622, CAS No. 65447-77-0

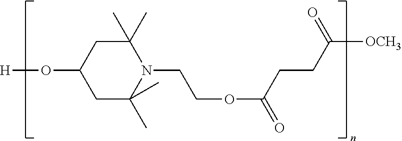

### B/2V

1-methylimidazole

### B/3V

2-phenylimidazole

### B/4V

imidazole

### B/5V

polyamidine:

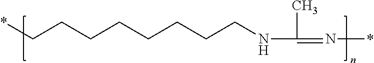

n=23
Mₙ=3871 g/mol

### Component C)

MgO d₅₀=73 μm

### Component D1)

antioxidant: Irganox® 245 from Ciba Geigy:

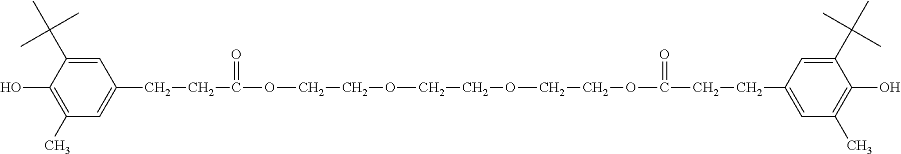

### Component D2:

synthetic magnesium silicate: Ambosol® from Societé Nobel, Puteaux with the following properties:
MgO content ≧14.8% by weight
SiO₂ content ≧59% by weight
SiO₂:MgO ratio 2.7 mol/mol
Bulk density 20 to 30 g/100 ml
Ignition loss <25% by weight

### Component D3)

glyceryl distearate: Loxiol® VP 1206 from Henkel KGaA

### Component D4)

polyamide oligomer with a molecular weight of about 3000 g/mol, prepared from caprolactam, hexamethylenediamine, adipic acid and, as a molecular weight regulator, propionic acid based on examples 5-4 of U.S. Pat. No. 3,960,984 (“PA-dicapped”).

### Component D5)

### Irganox® 1010 FF

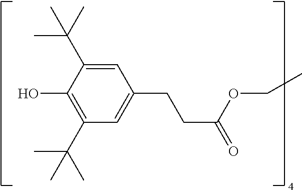

### Component D6)

melamine-formaldehyde condensate

To prepare the molding materials, component A was mixed with the amounts of components D1 to D6 stated below in a dry mixer at a temperature of 23° C. The mixture thus obtained was introduced with B and C into a twin-screw extruder (ZSK 30 from Werner & Pfleiderer) with devolatilization facility, homogenized at 220° C. and devolatilized, and the homogenized mixture was extruded through a nozzle and pelletized.

Component A in the examples comprised in each case

D1 0.35% by weight
D2 0.05% by weight
D3 0.15% by weight
D4 0.04% by weight
D5 0.1% by weight
D6 0.2% by weight

The following measurements were carried out:

Weight loss, mechanical properties (tensile test) (on specimens of thickness 4 mm, ISO 527 Type 1A) and specimens of thickness 4 mm for the Charpy impact strength (ISO 179/1eA) were measured before and after storage in
1) Haltermann CEC 91-A-81 at 100° C. (bath exchange 1× in 14 days) and
2) mixture of 75% CEC RF 06-03 diesel+25% biodiesel (DIN EN 14214) at 110° C. (bath exchange 2×per week).

### Inventive Examples

### Example 1:A)+0.5 B/1+2 C

### Example 2:A)+0.5 B/2+2 C

### Comparative Examples

### V1 A+0.8 B/1V

### V2 A+0.5 B/2V+2C

### V3 A+0.1 B/3V+2C

### V4 A+0.1 B/4V+2C

### V5 A+0.5 B/5V+2C

The results of the measurements can be taken from the table.

| | Haltermann Diesel CEC RF 91-A-81 | | | | | |
|---|---|---|---|---|---|---|
| | Modulus of | | Yield | Elongation at | Notched impact | |
| | elasticity | Yield stress | elongation | break | strength | Mass loss |
| Examples | [MPa] | [MPa] | [%] | [%] | [kJ/m²] | [%] |
| V5 - 0 days | 3080 | 66.9 | 8.42 | 20.9 | 4.47 | 0 |
| V5 - 7 days | 2766 | 67.6 | 9.95 | 16.2 | 3.43 | −5.7 |
| V5 - 14 days | 2761 | 67.2 | 8.56 | 11.3 | 5.71 | −15 |
| V5 - 28 days | 2663 | 65.9 | 9.99 | 14.8 | 5.59 | −15.8 |
| V5 - 56 days | 2788 | 65.4 | 8.91 | 12.8 | 4.35 | −17.84 |
| V2 - 0 days | 2936 | 66 | 8.82 | 28.3 | 5.52 | 0 |
| V2 - 7 days | 2710 | 67.5 | 10.2 | 23.8 | 5.31 | 0.31 |
| V2 - 14 days | 2851 | 69.8 | 10.4 | 18.8 | 4.81 | 0.35 |
| V2 - 28 days | 2570 | 65 | 10.9 | 16.6 | 5.55 | −0.24 |
| V2 - 56 days | 2723 | 65.8 | 10.4 | 15.1 | 3.26 | −3.1 |
| V3 - 0 days | 3017 | 66.9 | 8.76 | 26.7 | 5.48 | 0 |
| V3 - 7 days | 2697 | 67.6 | 10.8 | 29 | 5.23 | 0.61 |
| V3 - 14 days | 2804 | 69.1 | 10.7 | 20.9 | 5.55 | −0.5 |
| V3 - 28 days | 2598 | 66.2 | 11.2 | 20.8 | 5.74 | −3.69 |
| V3 - 56 days | 2733 | 66.3 | 10.6 | 14.6 | 3.07 | −6.44 |
| V4 - 0 days | 2969 | 66.8 | 8.78 | 26.1 | 5.52 | 0 |
| V4 - 7 days | 2716 | 67.6 | 10.6 | 28.4 | 5.31 | 0.55 |
| V4 - 14 days | 2737 | 68.8 | 11.1 | 24.4 | 5.41 | 0.61 |
| V4 - 28 days | 2616 | 66.8 | 11.9 | 25.3 | 4.8 | 0.3 |
| V4 - 56 days | 2676 | 65.4 | 11.2 | 12 | 5.36 | −1.44 |
| V1 - 0 days | 2914 | 67.3 | 9.81 | 31.9 | 5.41 | 0 |
| V1 - 7 days | 2794 | 68.7 | 10.8 | 21.8 | 3.3 | −2.8 |
| V1 - 14 days | 2819 | 69.2 | 10.7 | 19.7 | 5.62 | −14 |
| V1 - 28 days | 2755 | 68.1 | 10.3 | 17.6 | 7.99 | −33.64 |
| V1 - 56 days | | | | | | −73.8 |
| Example 1 - 0 days | 2957 | 67.1 | 8.79 | 24 | 5.44 | 0 |
| Example 1 - 7 days | 2771 | 68.1 | 10.2 | 18.4 | 4.7 | 0.51 |
| Example 1 - 14 days | 2680 | 67.1 | 10.9 | 16.4 | 5.2 | 0.29 |
| Example 1 - 28 days | 2665 | 67.3 | 11 | 22.2 | 5.19 | 0.52 |
| Example 1 - 56 days | 2699 | 65.9 | 10.5 | 13.2 | 5.39 | −0.63 |
| Example 2 - 0 days | 2980 | 67.2 | 8.54 | 25.7 | 5.04 | 0 |
| Example 2 - 7 days | 2768 | 68 | 10.1 | 24.4 | 5.2 | 0.41 |
| Example 2 - 14 days | 2703 | 67 | 10.6 | 20.1 | 5.37 | 0.16 |
| Example 2 - 28 days | 2647 | 67.1 | 11.1 | 24.1 | 5.4 | 0.26 |
| Example 2 - 56 days | 2665 | 65.7 | 10.4 | 14.2 | 4.53 | −0.23 |

75% CEC RF 06-03 diesel + 25% DIN EN 14214 biodiesel

| | Modulus of | | Yield | Elongation at | Notched impact | |
|---|---|---|---|---|---|---|
| | elasticity | Yield stress | elongation | break | strength | Mass loss |
| Examples | [MPa] | [MPa] | [%] | [%] | [kJ/m²] | [%] |
| V5 - 0 days | 3080 | 66.9 | 8.42 | 20.9 | 4.47 | 0 |
| V5 - 7 days | 2614 | 67.5 | 12.3 | 16.4 | 3.94 | 0.78 |
| V5 - 14 days | 2529 | 66.8 | 12.6 | 14.1 | 3.45 | 0.7 |
| V5 - 28 days | 2518 | 65.7 | 8.68 | 8.68 | 1.58 | 0.49 |
| V5 - 56 days | 2416 | 55.9 | 5.73 | 5.73 | 1.49 | −0.07 |
| V2 - 0 days | 2936 | 66 | 8.82 | 28.3 | 5.52 | 0 |
| V2 - 7 days | 2617 | 67.3 | 12.3 | 27.3 | 5.34 | 0.33 |
| V2 - 14 days | 2512 | 66.5 | 12.9 | 20 | 5.37 | 0.29 |
| V2 - 28 days | 2438 | 63.8 | 7.59 | 7.59 | 3.19 | 0.04 |
| V2 - 56 days | 2278 | 49.8 | 4.51 | 4.51 | 1.53 | −0.8 |
| V3 - 0 days | 3017 | 66.9 | 8.76 | 26.7 | 5.48 | 0 |
| V3 - 7 days | 2637 | 67.9 | 12.3 | 27.2 | 5.4 | 0.53 |
| V3 - 14 days | 2539 | 67.2 | 12.7 | 21.8 | 5.15 | 0.6 |
| V3 - 28 days | 2476 | 65.2 | 9.74 | 9.97 | 3.63 | 0.44 |
| V3 - 56 days | 2369 | 50.9 | 4.46 | 4.46 | 1.51 | −0.05 |
| V4 - 0 days | 2969 | 66.8 | 8.78 | 26.1 | 5.52 | 0 |
| V4 - 7 days | 2616 | 67.6 | 12.2 | 19.3 | 5.26 | 0.41 |
| V4 - 14 days | 2521 | 66.6 | 12.4 | 15.9 | 4.76 | 0.47 |
| V4 - 28 days | 2352 | 52.7 | 4.25 | 4.25 | 1.69 | 0.03 |
| V4 - 56 days | 2322 | 45.2 | 3.58 | 3.58 | 1.48 | −1.16 |
| V1 - 0 days | 2836 | 66.6 | 9.29 | 32.6 | 5.42 | 0 |
| V1 - 7 days | 2486 | 67.1 | 13.1 | 35.3 | 5.26 | 0.6 |
| V1 - 14 days | 2370 | 65.9 | 13.7 | 37.6 | 5.98 | 0.75 |
| V1 - 28 days | 2254 | 65.5 | 14.7 | 26.1 | 5.15 | 0.85 |
| V1 - 56 days | 2360 | 56.6 | 5.25 | 5.25 | 2.53 | 0.44 |
| Example 1 - 0 days | 2957 | 67.1 | 8.79 | 24 | 5.44 | 0 |
| Example 1 - 7 days | 2645 | 68.1 | 11.7 | 21.5 | 4.6 | 0.26 |
| Example 1 - 14 days | 2555 | 65.6 | 11 | 11.6 | 3.15 | 0.25 |
| Example 1 - 28 days | 2376 | 60.9 | 7.79 | 7.79 | 1.97 | −0.07 |
| Example 1 - 56 days | 2395 | 52.6 | 4.77 | 4.77 | 1.6 | −1.02 |
| Example 2 - 0 days | 2980 | 67.2 | 8.54 | 25.7 | 5.04 | 0 |
| Example 2 - 7 days | 2701 | 68 | 10.7 | 14.7 | 3.26 | 0.14 |
| Example 2 - 14 days | 2497 | 64.3 | 11 | 11.6 | 3.02 | 0.13 |
| Example 2 - 28 days | 2414 | 61.1 | 8.33 | 8.33 | 1.68 | −0.12 |
| Example 2 - 56 days | 2403 | 44.5 | 3.04 | 3.04 | 1.59 | −0.91 |

1-9. (canceled)

10. A thermoplastic molding material comprising
A) 10 to 99.99% by weight of a polyoxymethylene homo- or copolymer,
B) 0.01 to 5% by weight of an imidazole of the general formula 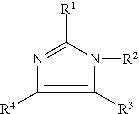
where the R¹ to R⁴ radicals are each independently defined as follows:
R¹ is an alkyl radical having 1 to 5 carbon atoms,
R² to R⁴ are each independently hydrogen, an alkyl radical having 1 to 5 carbon atoms,
C) 0 to 5% by weight of an alkaline earth metal oxide,
D) 0 to 80% by weight of further additives,
where the sum of the percentages by weight of components A) to D) does not exceed 100%.

11. A thermoplastic molding material comprising
A) 10 to 99.98% by weight of a polyoxymethylene homo- or copolymer,
B) 0.01 to 5% by weight of an imidazole of the general formula 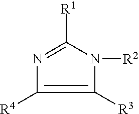
where the R¹ to R⁴ radicals are each independently defined as follows:
R¹ is an alkyl radical having 1 to 5 carbon atoms,
R² to R⁴ are each independently hydrogen, an alkyl radical having 1 to 5 carbon atoms,
C) 0.01 to 5% by weight of an alkaline earth metal oxide,
D) 0 to 80% by weight of further additives,
where the sum of the percentages by weight of components A) to D) does not exceed 100%.

12. The thermoplastic molding material according to claim 10, comprising magnesium oxide as component C).

13. The thermoplastic molding material according to claim 10, in which component C) comprises less than 10 000 ppm of metal impurities.

14. The thermoplastic molding material according to claim 10, in which component C) has a mean particle size d₅₀ of 10 to 200 μm.

15. The thermoplastic molding material according to claim 10, wherein R¹ of component B) is a methyl radical or ethyl radical.

16. The thermoplastic molding material according to claim 10, wherein R², R³, R⁴ are each hydrogen or a methyl radical or ethyl radical.

17. The thermoplastic molding material according to claim 11, comprising magnesium oxide as component C).

18. The thermoplastic molding material according to claim 11, in which component C) comprises less than 10 000 ppm of metal impurities.

19. The thermoplastic molding material according to claim 11, in which component C) has a mean particle size d₅₀ of 10 to 200 μm.

20. The thermoplastic molding material according to claim 11, wherein R¹ of component B) is a methyl radical or ethyl radical.

21. The thermoplastic molding material according to claim 11, wherein R², R³, R⁴ are each hydrogen or a methyl radical or ethyl radical.

22. A process for producing a fiber, a film or a molding which comprises utilizing the thermoplastic molding material according to claim 10.

23. A process for producing a fiber, a film or a molding which comprises utilizing the thermoplastic molding material according to claim 10.

24. A fiber, film or molding, obtainable from the thermoplastic molding material according to claim 10.

25. A fiber, film or molding, obtainable from the thermoplastic molding material according to claim 11.
